(19) United States
(12) Patent Application Publication
(10) Pub. No.: US 2014/0053962 A1
(43) Pub. Date: Feb. 27, 2014

(54) WEAR-OPTIMIZED TREAD FOR A HEAVY-VEHICULE TIRE, AND OPTIMIZATION METHOD

(71) Applicant: Sylvie Lhospitalier, Clermont-Ferrand-Cedex 9 (FR)

(72) Inventor: Sylvie Lhospitalier, Clermont-Ferrand-Cedex 9 (FR)

(73) Assignee: Michelin Recherche Et Technique S.A., Granges-Paccot (CH)

(21) Appl. No.: 14/003,306

(22) PCT Filed: Mar. 21, 2012
(86) PCT No.: PCT/EP2012/054946

§ 371 Date: Nov. 18, 2013

(30) Foreign Application Priority Data
Mar. 25, 2011 (FR) 1152509

(51) Int. Cl. B60C 11/13

(52) U.S. Cl. CPC B60C 11/124
USPC 152/209.18; 29/592

(57) ABSTRACT

Tread for a tire for an axle of a heavy goods vehicle, comprising at least four grooves of generally circumferential orientation delimiting a plurality of ribs comprising two shoulder ribs axially delimiting the tread and intermediate ribs and a central rib, the intermediate and central ribs each being provided with a plurality of sipes having a width of less than 2 mm, and of generally transverse orientation, inclined at an average angle relative to a direction perpendicular to the running surface of the tread in the new state, this average angle being at least equal to 5 degrees and oriented such that the resultant force exerted, when running in the zone of contact with the road surface, by the said road surface on the tread tends to straighten out the sipes towards an average zero angle relative to this same perpendicular direction, this tread being characterized in that the following relations are satisfied:

$$0.660 〈 Ai * Ac 〈 0.755 \\ 0.835 〈 \frac{Ai}{Ae} 〈 0.910$$

### BACKGROUND

1. Field

The present invention relates to treads for tires designed to be fitted to the front axle of transport vehicles and more particularly heavy goods vehicles, which tires are likely to make long journeys at steady speed.

2. Description of Related Art

These tires comprise a carcass reinforcement comprising a plurality of reinforcements placed radially, this carcass reinforcement itself being surmounted by a crown reinforcement extending in the transverse (also called axial) and circumferential (also called longitudinal) directions. This crown reinforcement consists of at least two plies superposed on one another, each ply being formed of a rubber mixture reinforced by a plurality of cables or wires that are not very stretchable, preferably made of steel, placed parallel to one another in one and the same ply and in a direction forming an angle at most equal to 40 degrees with the circumferential direction, the cables being crossed from one ply to another. This crown reinforcement may be supplemented, on the one hand by one complete ply or two half-plies comprising not very stretchable cables forming with the circumferential direction an angle of between 45 degrees and 80 degrees, on the other hand by at least one ply formed of cables called “elastic” cables placed radially on the outside of the crown plies of which the reinforcing cables form an angle of less than 40°. Other reinforcement plies may be employed as required.

The crown reinforcement is also surmounted radially on the outside by a tread made with at least one composition with a rubber base of which the radially outermost portion of the tire forms a running surface designed to come into contact with a road surface during the running of this tire mounted on a vehicle.

In order to obtain a satisfactory grip performance when running on a road surface covered with water, this tread is provided on its outer surface, in the case of tires designed to be fitted to the front steering axle of heavy goods vehicles, with a plurality of grooves of generally circumferential orientation. These grooves form in the tread a sculpture comprising a plurality of continuous ribs, each rib having a radially outer contact face (this contact face forming a portion of the running surface of the tread) and lateral walls that may be substantially perpendicular to the contact face of the rib or else able to form a non-zero relief angle with this contact face. In order to further improve the grip performance, it is known practice to provide certain of the ribs of a tread with a plurality of grooves and/or sipes of transverse or substantially transverse orientation (that is to say with an angle at most equal to 45 degrees with the transverse or axial direction). These transverse cuts and the longitudinal grooves delimit a plurality of patterns having, when running, a leading edge or ridge, that is to say a ridge coming into contact with the road surface before the rest of the contact surface of each pattern, and a trailing ridge. Furthermore, these same ribs and patterns have ridges oriented circumferentially, these ridges playing an important role during turning manoeuvres.

In use with customers, it was possible to find that wear could occur that is known as “uneven” because it developed in an uneven manner over the whole of the running surface in contact with a road surface.

It has been possible, for example, to observe the appearance in the vicinity of the trailing edges an uneven wear that is more pronounced than over the rest of the tread. In order to solve this problem, a solution described in the patent application published under number WO 2002-055324 has been proposed.

Another type of uneven wear has been able to be observed on tires for steering axles and according to which, the longitudinal ridges of the shoulder ribs (“shoulder ribs” should be understood in this instance to be the two ribs axially delimiting the tread) have zones of more pronounced wear than the rest of these ribs.

In order to reduce this uneven wear appearing on the shoulder ribs, it has been proposed in patent EP-0384182-B1 to provide only the other central and intermediate ribs of a tread with a plurality of sipes inclined in one and the same direction of inclination in order to adapt, when running, the lengths of flattening of each central and intermediate rib. “Central rib” means the rib traversed by the equatorial plane of the tire and “intermediate rib” is any rib situated between a shoulder rib and the central rib. If there is no central rib, it is considered that there are only intermediate ribs.

According to this patent document, the sipes with which the central and intermediate ribs are provided are transverse and substantially parallel with one another, these sipes being inclined at an angle of between 5° and 25° relative to a direction perpendicular to the running surface of the tread such that the resultant force exerted, when running in the zone of contact with the ground, by the ground on the tread tends to straighten out the sipes to a zero inclination relative to the said perpendicular direction. It should be noted that, on the front steering axle, on average not subjected to a resultant force of driving type, the tires are subjected to an overall resultant force which tends to slow down the vehicle and which is directed in the direction opposite to the direction of movement of the vehicle.

Although the disclosures of document WO 2002-055324 and the disclosures of EP-0384182-B1 make it possible to obtain a heavy-vehicle tire for a steering axle with improved uneven wear performance, it is necessary in this instance to recognize that the change in heavy goods vehicles and the ever-increasing need in terms of tire performance have led the filing companies to undertake studies to obtain a further improvement in the wear of these tires and notably in uneven wear on the longitudinal ridges of the intermediate ribs.

### DEFINITIONS

A rib is a raised element formed on a tread, this element being delimited by two grooves of circumferential orientation. A rib comprises two lateral walls and a contact face, the latter being designed to come into contact with the road surface.

A block is a raised element formed on a tread, this element being delimited by hollows or grooves and comprising lateral walls and a contact face, the latter being designed to come into contact with the road surface during running.

“Radial direction” means a direction that is perpendicular to the rotation axis of the tire (this direction corresponds to the direction of the thickness of the tread).

“Axial or transverse direction” means a direction parallel to the rotation axis of the tire.

“Circumferential direction” means a direction that is tangential to any circle centered on the rotation axis. This direction is perpendicular to both the axial direction and a radial direction.

The generic term “cut” is either a groove or a sipe, one or the other being obtained by molding or by a cutting operation. A cut corresponds to the space delimited by walls of material facing one another and at a non-zero distance from one another. The difference between a sipe and a groove is precisely this distance separating the facing walls; in the case of a sipe, this distance is appropriate for allowing at least partially the placing in contact of the opposite walls when passing in contact with the road surface. This distance for a sipe is in this instance preferably at most equal to 2 millimeters (mm). In the case of a groove, the walls of this groove cannot come into contact with one another in the usual running conditions.

The main direction of a sipe on the running surface corresponds to the average direction passing through the furthermost points of the sipe on the running surface of the tread in the new, unused state.

The secondary direction of a sipe is defined as being the direction perpendicular to the main direction of a sipe and extending along the sipe in the thickness of the tread.

### SUMMARY

The object of the present invention is to improve the wear performance and more precisely the uneven wear performance on the shoulder ribs and the intermediate ribs of the tires for the front steering axle of heavy goods vehicles, while obtaining one and the same speed of wear for all the ribs, these performance improvements conferring on the tire a service life that is increased relative to the tire of the prior art described notably in EP-0384182-B1.

Accordingly, the subject of the invention is a tread for a tire designed to be fitted to an axle of a heavy goods vehicle, this tire comprising a radial carcass reinforcement surmounted by a crown reinforcement, this tread comprising at least four grooves of generally circumferential orientation delimiting a plurality of ribs comprising two shoulder ribs axially delimiting the tread and intermediate ribs and a central rib, the intermediate and central ribs each being provided with a plurality of sipes having a width of less than 2 mm, and of generally transverse orientation, these sipes being inclined at an average angle relative to a direction perpendicular to the running surface of the tread in the new state, this average angle being at least equal to 5 degrees and oriented such that the resultant force exerted, when running in the zone of contact with the road surface, by the said road surface on the tread tends to straighten out the sipes towards an average zero angle relative to this same perpendicular direction, this tread being characterized in that the following relations are satisfied:

$$0.660 〈 Ai * Ac 〈 0.755 \\ 0.835 〈 \frac{Ai}{Ae} 〈 0.910$$

the coefficients Ae, Ai and Ac being calculated, respectively for each shoulder rib, each intermediate rib and for the central rib, by using the following formulas:

Aj=AXj*AYj

where:

$$AXj = \frac{1}{1 + \frac{1}{3} {( \frac{PSj}{pj - ( EpLj + PLj * tan ALPHAj )} )}^{2}}$$

$$and$$

$$AYj = \frac{1}{1 + \frac{1}{3} {( \frac{PSj}{Lrj} )}^{2}}$$

the index j taking the value c for the central rib, the value i for each intermediate rib, the value e for each shoulder rib, and where:

PSj: height of the rib of index j,

Lrj: width of the rib of index j,

PLj: average depth of the sipes of the rib of index j,

EpLj: average width of the sipes of the rib of index j,

pj: average pitch of the sipes of the rib of index j,

ALPHAj: angle of inclination of the sipes of the rib of index j.

The height PSj of a rib of index j is taken as the average of the depths of the grooves delimiting the said rib of index j. For the shoulder rib, this height is equal to the depth of the groove separating this shoulder rib from the intermediate rib that is axially closest.

The symbol “*” employed above indicates a multiplication operation.

All the values cited above refer to dimensions taken on the tread in the new state, that is to say before any running.

According to a variant of the invention, the tread is such that the following relation is also satisfied:

0.780(Ai*Ae(0.845

Preferably, the pitch of the sipes on the ribs reduces as you go from the shoulder ribs to the central rib. Thus, by increasing the number of sipes on the ribs close to the central portion of the tread, it is possible to increase the driving power of the axially outer ribs.

Preferably, the average width of the sipes of each rib increases as you go from the shoulder ribs to the central rib. Thus, by increasing the width of the sipes on the central portion of the tread, it is possible to increase the driving power of the axially outer ribs.

Advantageously, a tread according to the invention is used with a tire designed to be fitted to the front steering axle of a heavy goods vehicle.

In the case in which the tread has more than one intermediate rib between the central rib and the shoulder rib, the relations given above are applied to the intermediate rib axially closest to the shoulder rib.

In certain applications, it may be necessary to modulate the reduction in rigidity associated with the presence of sipes on the intermediate ribs by having the depth of the sipes varying from one side to the other of the said ribs. Preferably, the depth of these sipes in the intermediate ribs is less on the side of the groove delimiting the shoulder rib. This forms a kind of bridging between the facing walls delimiting each sipe, this bridging being higher on the side of the shoulder rib and reducing towards the equatorial plane of the tire. Preferably, the maximum height of this bridging is at most equal to 45% of the height of the rib in which the sipes having this bridging are formed, the height of the rib being equal to the depth of the longitudinal grooves delimiting it. In such a configuration, the sipes of each intermediate rib have depths which vary between a maximum depth and a minimum depth, the minimum depth being at least equal to 55% of the height PSi of the intermediate rib.

In such a case, the depth of the sipe in the intermediate ribs to be taken into account in the calculation of the coefficients Ae, Ai and Ac is an average depth obtained as being the depth of a sipe having a bridging of constant height and the same surface as the bridging in question.

Furthermore, the subject of the invention is a method for optimizing a tread for a tire designed for a steering axle of a heavy goods vehicle according to which a tread is constructed with at least four grooves of circumferential orientation delimiting a plurality of ribs comprising two shoulder ribs axially delimiting the tread and intermediate ribs and a central rib, the intermediate and central ribs each being provided with a plurality of sipes having a width of less than 2 mm, and of generally transverse orientation, these sipes being inclined at an average angle relative to a direction perpendicular to the running surface of the tread in the new state, this average angle being at least equal to 5 degrees and oriented such that the resultant force exerted, when running in the zone of contact with the road surface, by the said road surface on the tread tends to straighten out the sipes towards an average zero angle relative to this same perpendicular direction.

This optimization method consists in setting certain dimensional parameters and then in finding the other dimensional parameters until the following relations are satisfied:

$$0.660 〈 Ai * Ac 〈 0.755 \\ 0.835 〈 \frac{Ai}{Ae} 〈 0.910$$

the coefficients Ae, Ai and Ac being calculated, respectively for each shoulder rib, each intermediate rib and for the central rib, by using the following formulas:

$$Aj = AXj * AYj$$

$$where$$

$$AXj = \frac{1}{1 + \frac{1}{3} {( \frac{PSj}{pj - ( EpLj + PLj * tan ALPHAj )} )}^{2}}$$

$$and$$

$$AYj = \frac{1}{1 + \frac{1}{3} {( \frac{PSj}{Lrj} )}^{2}}$$

the index j taking the value c for the central rib, the value i for each intermediate rib, the value e for each shoulder rib, and where:

PSj: height of the rib of index j,

Lrj: width of the rib of index j,

PLj: average depth of the sipes of the rib of index j,

EpLj: average width of the sipes of the rib of index j,

pj: average pitch of the sipes of the rib of index j,

ALPHAj: angle of inclination of the sipes of the rib of index j.

By virtue of applying this optimization, it is therefore possible to determine a distribution of the rigidities of the various shoulder, intermediate and central ribs for the purpose of making the tread operate better in flattening in contact with the road surface so that the wear of this tread is even over the whole tread.

Other features and advantages of the invention will emerge from the description given below with reference to the appended drawings which show, as non-limiting examples, variant embodiments of the subject of the invention.

### BRIEF DESCRIPTION OF THE FIGURES

FIG. 1 shows a view of a tread according to the invention;

FIG. 2 shows a partial view of an intermediate rib of the tread shown in FIG. 1;

FIG. 3 shows a variant of a tire according to the invention.

### DESCRIPTION OF THE FIGURES

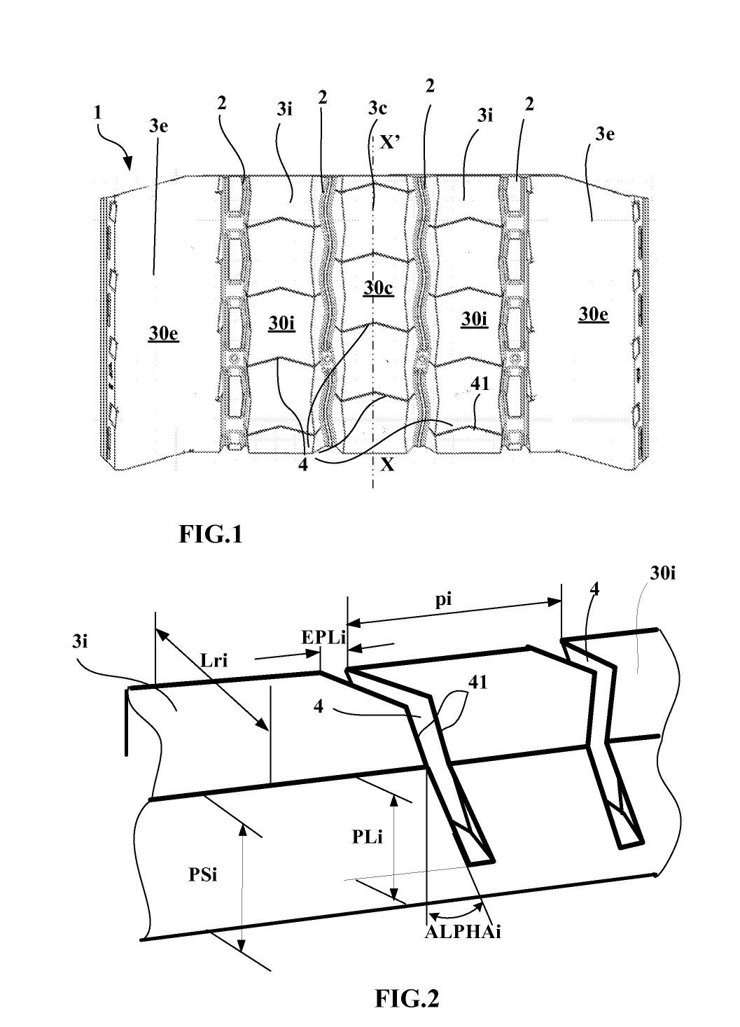

FIG. 1 shows a view of a tread 1 according to the invention designed to form part of a tire of dimension 315/80 R22.5 itself designed to be fitted to the front axle of a heavy goods vehicle. This tread 1 comprises four zigzag grooves 2 oriented in the longitudinal direction indicated by the direction XX′ in the figure (or else the circumferential direction when this tread is incorporated into a tire). These grooves have depths equal to 16.5 mm.

These grooves 2 delimit several ribs: a shoulder rib 3e at each lateral edge of the tread, a median or central rib 3c and an intermediate rib 3i on each side of the central rib 3c. Each rib 3j (the index j taking the values e, i or c) comprises a contact face 30j designed to come into contact with a road surface when running and lateral faces cutting the contact faces along ridges.

The median or central rib 3c is located so as to be traversed by a plane called the equatorial plane of the tire, the line of which on the plane of the figure is indicated by the line XX′, this equatorial plane being perpendicular to the rotation axis and passing through or substantially through the points at equal distance from the lateral edges of the tread (that is to say the axially outermost ridges of the tread).

In this instance, the shoulder ribs 3e have no sipe while the central ribs 3c and intermediate ribs 3i are each provided with a plurality of sipes 4 of which the intersections with the contact faces of these ribs form V-shaped ridges 41 of the same orientation. Furthermore, each sipe 4 has an inclination relative to a plane perpendicular to the contact surface where the said sipe opens, this average inclination being equal to 7 degrees. Thus, the rigidity of the shoulder rib 3e is in no way reduced by the presence of sipes and it is possible to produce a staging of the rigidities of the ribs as you go from the shoulder (the most rigid rib) to the central rib.

All the sipes 4 are inclined in the same manner such that, when running, the resultant force exerted, in the zone of contact with the road surface, by the said road surface on the tread tends to straighten out the sipes, that is to say so as to reduce the inclination of the sipes relative to this same perpendicular direction. It is known that, on a non-driving, steering axle, the average resultant force exerted by the road surface on the tread is a force called a “braking” force, that is to say a force tending to oppose the movement of the vehicle when running. This braking force is oriented in a direction opposite to the direction of movement of the vehicle.

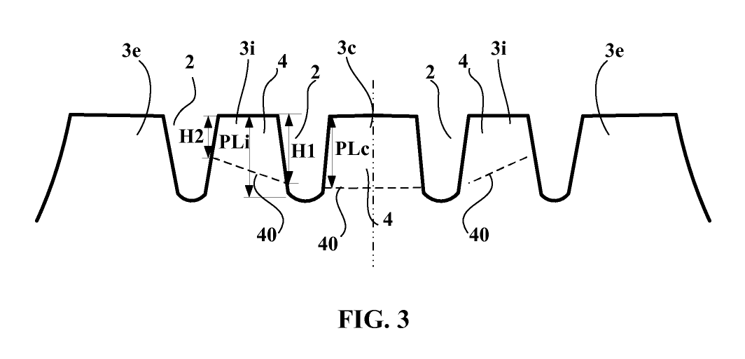

These sipes 4 have a depth that is less than the depth of the grooves 2 as can be seen in FIG. 2 showing only a portion of an intermediate rib 3i.

This FIG. 2 shows only a portion of the intermediate rib 3i delimited by the longitudinal grooves 2. Each sipe 4 opens on the contact face 30i to form two ridges 41. The depth PLi of each sipe 4 is equal to 14.5 mm while the average depth of the grooves 2 which delimit this rib 3i is equal to 16.5 mm.

Hereinafter, the numerical data are assembled for this tread according to the invention:

PSc: height of center rib=16.5 mm

PSi: height of intermediate rib=16.5 mm

PSe: height of shoulder rib=16 mm

Lrc: width of center rib=32 mm

Lri: width of intermediate rib=32 mm

Lre: width of shoulder rib=52 mm

EpLc: average width of the sipes on the central rib=0.6 mm

EpLi: average width of the sipes on the intermediate rib=0.6 mm

PLc: average depth of the sipes on the central rib=14.5 mm

PLi: average depth of the sipes on the intermediate rib=14.5 mm

PLe: average depth of the sipes on the rib=0 mm (there are no sipes on the shoulder rib)

pc: pitch of the sipes on the central rib=35 mm

pi: pitch of the sipes on the intermediate rib=35 mm

pe: pitch of the sipes on the shoulder rib=3000 mm

By convention, when a rib has no sipe, the value of this parameter “pe” is equal to the perimeter of the said rib.

ALPHAc: average angle of inclination of the sipes on the central rib=7 degrees

ALPHAi: average angle of inclination of the sipes on the intermediate rib=7 degrees

ALPHAe: average angle of inclination of the sipes on the shoulder rib=0 degree

These parameter values then give the coefficients:

AXc=0.921

AYc=0.919

AXi=0.921

AYi=0.919

AXe=1.00

AYe=0.969

Ai=0.846

Ac=0.846

Ae=0.969

These values lead to:

Ai*Ac=0.716

Ai/Ae=0.873

Ai*Ae=0.821

These values effectively satisfy the criteria recommended by the invention, namely:

$$0.660 〈 Ai * Ac = 0.716 〈 0.755 \\ 0.835 〈 \frac{Ai}{Ae} = 0.873 〈 0.910 \\ 0.780 〈 Ai * Ae = 0.821 〈 0.845$$

For a reference tire, of which the pattern of the tread sculpture is as shown in FIG. 2 of the document of the prior art EP-0384182-B1, considered as the prior art closest to the present invention, the values are indicated below for one and the same tire dimension (315/80 R22.5).

PSc: height of center rib=17.5 mm

PSi: height of intermediate rib=17.5 mm

PSe: height of shoulder rib=17.5 mm

PLc=14.5 mm

PLi=14.5 mm

PLe=0 mm

Lrc: width of center rib=32 mm

Lri: width of intermediate rib closest to the shoulder rib=32 mm

Lre: width of shoulder rib=50 mm

EpLc: average width of the sipes on the central rib=0.6 mm

EpLi: average width of the sipes on the intermediate rib=0.6 mm

EpLe: average width of the sipes on the shoulder rib=0 mm

pc: pitch of the sipes on the central rib=27 mm

pi: pitch of the sipes on the intermediate rib=27 mm

pe: pitch of the sipes on the shoulder rib=3000 mm

ALPHAc: average angle of inclination of the sipes on the central rib=7 degrees

ALPHAi: average angle of inclination of the sipes on the intermediate rib=7 degrees

ALPHAe: average angle of inclination of the sipes on the shoulder rib=0 degree

Value of the coefficients:

$$AXc = 0.856$$

$$AYc = 0.909$$

$$AXi = 0.856$$

$$AYi = 0.909$$

$$AXe = 1.00$$

$$AYe = 0.961$$

$$Ai = 0.778$$

$$Ac = 0.778$$

$$Ae = 0.961$$

$$Ai * Ac = 0.606$$

$$Ai / Ae = 0.810$$

$$Ai * Ae = 0.758$$

$$0.660 〈 Ai * Ac = 0.606 〈 0.755 \\ 0.835 〈 \frac{Ai}{Ae} = 0.810 〈 0.910 \\ 0.780 〈 Ai * Ae = 0.758 〈 0.845$$

As can be seen, the values obtained for the tire of the closest prior art are very clearly outside the ranges claimed here.

In the foregoing formulas, the operator “*” indicates a multiplication operation and the operator “/” indicates a division operation.

FIG. 3 shows a variant of a tire according to the invention according to which the tread of this tire designed for a heavy goods vehicle comprises two intermediate ribs (3i) delimited by circumferential grooves (2), one central rib (3c), and two shoulder ribs (3e) axially delimiting the said tread. Each intermediate rib has a height PSi corresponding to the depth of the grooves (2) delimiting this rib. Furthermore, each intermediate rib (3i) is provided with a plurality of sipes 4, each sipe 4 having a sipe bottom 40 which is inclined relative to a transverse direction. Thus, each sipe 4 has a non-uniform depth between the two lateral faces of the intermediate rib. On the side corresponding to the groove delimited by the intermediate rib and by the shoulder rib, the depth H1 of the sipe is of the order of 60% of the height PLi of the intermediate rib while on the other side the depth H2 of the same sipe is equal to 80% of the same height PSi. In this particular case, the calculation of the coefficients Ae, Ai and Ac is made by employing for depth PLi of the sipes of each intermediate rib an average value calculated by making the average of the depths H1 and H2 (that is to say PLi=H1/2+H2/2). Finally, the central rib 3c is provided with sipes of which the depth PLc is constant and slightly greater than the maximum depth of the sipes of the intermediate ribs.

Since the invention has been described in a general manner and by means of several variants, it must be understood that this invention is not limited solely to these variants described and represented. It is clear that various modifications can be made thereto without departing from the general context of the present invention.

In all the present cases, those skilled in the art are capable of adapting the shape of each sipe, notably by providing the presence of means capable of limiting the relative movements of one face relative to the facing face (for example by providing the formation of reliefs interacting with one another in order to limit or even inhibit any relative movement of the faces in at least one direction). It is also possible to provide the portions of the innermost sipes of the tread with enlargements to limit the concentrations of force and thus reduce the possibilities of cracking of the material.

1. A tread for a tire adapted to fit to an axle of a heavy goods vehicle, and comprising a radial carcass reinforcement surmounted by a crown reinforcement, this tread comprising:
at least four grooves of generally circumferential orientation;
a plurality of ribs delimited by said grooves, comprising
two shoulder ribs axially delimiting the tread,
intermediate ribs, and
a central rib,
wherein the intermediate and central ribs are each provided with a plurality of sipes having a width of less than 2 mm, and of generally transverse orientation, these sipes being inclined at an average angle relative to a direction perpendicular to the running surface of the tread in the new state, this average angle being at least equal to 5 degrees and oriented such that the resultant force exerted by the said road surface on the tread, when running in the zone of contact with the road surface, tends to straighten out the sipes towards an average zero angle relative to this same perpendicular direction, wherein the following relations are satisfied:
$$0.660 〈 Ai * Ac 〈 0.755 \\ 0.835 〈 \frac{Ai}{Ae} 〈 0.910$$
the coefficients Ae, Ai and Ac being calculated, respectively for each shoulder rib, each intermediate rib and for the central rib, by using the following formulas:
Aj=AXj*AYj
where:
$$AXj = \frac{1}{1 + \frac{1}{3} {( \frac{PSj}{pj - ( EpLj + PLj * tan ALPHAj )} )}^{2}}$$
$$and$$
$$AYj = \frac{1}{1 + \frac{1}{3} {( \frac{PSj}{Lrj} )}^{2}}$$
the index j taking the value c for the central rib, the value i for each intermediate rib, the value e for each shoulder rib, and where:
PSj: height of the rib of index j,
Lrj: width of the rib of index j,
PLj: average depth of the sipes of the rib of index j,
EpLj: average width of the sipes of the rib of index j,
pj: average pitch of the sipes of the rib of index j,
ALPHAj: angle of inclination of the sipes of the rib of index j.

2. The tread according to claim 1, wherein the following relation is also satisfied:
0.780 [symbol] Ai*Ae [symbol] 0.845

3. The tread according to claim 1, wherein the pitch of the sipes on each rib reduces from the shoulder ribs to the central rib.

4. The tread according to claim 1, wherein the average width of the sipes increases from each shoulder rib to the central rib.

5. The tread according to claim 1, wherein the shoulder ribs have no sipes.

6. The tread according to claim 1, wherein the sipes of each intermediate rib have depths which vary between a maximum depth and a minimum depth, the minimum depth being at least equal to 55% of the height PSi of the rib.

7. The tread according to claim 6, wherein the minimum depth of the sipes of each intermediate rib is situated on the side of the groove delimiting the shoulder rib.

8. The tread according to claim 1, wherein this tread is on a tire adapted to fit the front steering axle of a heavy goods vehicle.

9. A method for optimizing a tread for a tire adapted for a steering axle of a heavy goods vehicle, comprising constructing a tread having:
at least four grooves of circumferential orientation,
a plurality of ribs delimited by said grooves, comprising:
two shoulder ribs axially delimiting the tread,
intermediate ribs, and
a central rib,
wherein the intermediate and central ribs are each provided with a plurality of sipes having a width of less than 2 mm, and of generally transverse orientation, these sipes being inclined at an average angle relative to a direction perpendicular to the running surface of the tread in the new state, this average angle being at least equal to 5 degrees and oriented such that the resultant force exerted by the said road surface on the tread, when running in the zone of contact with the road surface, tends to straighten out the sipes towards an average zero angle relative to this same perpendicular direction, this optimization method consisting in setting certain dimensional parameters and then in finding the other dimensional parameters until the following relations are satisfied:
$$0.660 〈 Ai * Ac 〈 0.755 \\ 0.835 〈 \frac{Ai}{Ae} 〈 0.910$$
the coefficients Ae, Ai and Ac being calculated, respectively for each shoulder rib, each intermediate rib and for the central rib, by using the following formulas:
$$Aj = AXj * AYj$$
$$where$$
$$AXj = \frac{1}{1 + \frac{1}{3} {( \frac{PSj}{pj - ( EpLj + PLj * tan ALPHAj )} )}^{2}}$$
$$and$$
$$AYj = \frac{1}{1 + \frac{1}{3} {( \frac{PSj}{Lrj} )}^{2}}$$
the index j taking the value c for the central rib, the value i for each intermediate rib, the value e for each shoulder rib, and the dimensional parameters being chosen from the following list:
PSj: height of the rib of index j,
Lrj: width of the rib of index j,
PLj: average depth of the sipes of the rib of index j,
EpLj: average width of the sipes of the rib of index j,
pj: average pitch of the sipes of the rib of index j,
ALPHAj: angle of inclination of the sipes of the rib of index j.
